(19) United States
(12) Patent Application Publication
(10) Pub. No.: US 2015/0153841 A1
(43) Pub. Date: Jun. 4, 2015

(54) HUMAN-MACHINE INTERACTION SYSTEM AND INFRARED IMAGE CAPTURE DEVICE

(71) Applicant: TENCENT TECHNOLOGY (SHENZHEN) COMPANY LIMITED, Shenzhen (CN)

(72) Inventors: Jin FANG, Shenzhen (CN); Jinsong JIN, Shenzhen (CN); Jun CHENG, Shenzhen (CN)

(21) Appl. No.: 14/617,300

(22) Filed: Feb. 9, 2015

Related U.S. Application Data
(63) Continuation of application No. PCT/CN2013/083923, filed on Sep. 22, 2013.

(30) Foreign Application Priority Data
Sep. 29, 2012 (CN) 201210371671.X

(51) Int. Cl. G06F 3/03; G02B 5/20; H04N 5/33

(52) U.S. Cl. CPC G06F 3/0304; H04N 5/33; G02B 5/208

(57) ABSTRACT

The present invention relates to an infrared image capture device as part of a human-machine interaction system, and comprises an image capture device and a visible light filter. The image capture device is used to capture visible-light signals and infrared light signals. The visible-light filter is arranged in front of the image capture device in order to filter out any visible-light signals before a projected image enters the image capture device, causing said image capture device to capture the infrared light signals of the image. The present invention also provides a corresponding human-machine interaction system. The human-machine interaction system and infrared image capture device provided in the present invention are low in cost and can reliably and accurately capture the infrared light signals of an image.

The present application is a Continuation Application of International Application No. PCT/CN2013/083923 filed on Sep. 22, 2013 and entitled “HUMAN-MACHINE INTERACTIVE SYSTEM AND INFRARED IMAGE CAPTURE DEVICE”, which claims priority to a Chinese patent application No. 201210371671.X filed on Sep. 29, 2012 in the name of Tencent Technology (Shenzhen) Co. Ltd., entitled “Human-Machine Interaction System and Infrared Image Capture Device”, the disclosures of which are incorporated herein by reference in their entirety.

### TECHNICAL FIELD

The present disclosure relates to the field of computer technologies, especially to a human-machine interaction system and an infrared image capture device.

### TECHNICAL BACKGROUND

With the development of sciences and technologies, computers have been widely utilized in people's daily life and working. In human-machine interaction technologies based on computer vision, a camera is employed to capture and recognize user motions to implement the human-machine interaction. However, considering the high cost of such recognition due to generally complicated user motions, a typical and readily applicable human-machine interaction technology introduces indicating means such as an infrared positioning pen that is readily recognizable to the camera, thus the indicating means may be held by the user, and an infrared light indicating signal outputted by the infrared positioning pen is recognized to implement the human-machine interaction. Presently, a common projection-based large-scaled interactive whiteboard represents an implementation of such typical human-machine interaction technology, and achieves human-machine interactions through the cooperation between an infrared camera and an infrared light generator; or, a conventional camera that is modified to remove its infrared cut-off filter is adopted to capture an infrared light indicating signal outputted from the infrared light generator, to achieve human-machine interactions.

However, the human-machine interaction system with the infrared camera has a high cost due to the expensive infrared camera, and hence is difficult to be applied widely.

Moreover, in a human-machine interaction system incorporating a modified conventional camera, a projector of a Digital Light Procession (DLP) mode that employs imaging means such as a Digital Micromirror Device (DMD) projects an image in a way of point-by-point scanning, but the camera with a shutter operating at a speed of 30 frames per second can merely capture incomplete images before the completion of the scanning, thus the modified conventional camera cannot correctly capture images projected by the projector of the DLP mode. That is, the difference between the frame rates of the camera and the projector likely causes a defect of incomplete frame images. In addition, in an environment with strong light, an infrared light signal and a visible light signal in the image captured by the modified conventional camera are difficult to distinguish, it is hard for the computer to identify the position of the infrared light signal, resulting in a human-machine interaction failure.

### SUMMARY

An aspect of the present disclosure is to overcome the above defects in the existing human-machine interaction system by providing a new human-machine interaction system and an infrared image capture device of a low cost but capable of capturing an infrared light signal on an image reliably and precisely.

Objects of the present disclosure are achieved by the following technical schemes.

The present disclosure provides an infrared image capture device of a human-machine interaction system, and the infrared image capture device includes image capture means and a visible-light filter, where the image capture means is capable of capturing a visible light signal and an infrared light signal, and the visible-light filter is arranged in front of the image capture means and configured to filter out the visible light signal in an projected image before the projected image is captured by the image capture means, so that the image capture means captures the infrared light signal on the image.

The present disclosure provides a human-machine interaction system, including: a computation processing device, a projecting device, an infrared light generator and an infrared image capture device. The projecting device is connected with the computation processing device and configured to project an image from the computation processing device to a projection area to generate a projected image. The infrared light generator is configured to output an infrared light indicating signal on the projected image. The infrared image capture device is configured to capture the infrared light indicating signal on the projected image. Here, the infrared image capture device may include: image capture means and a visible-light filter, where the image capture means is capable of capturing a visible light signal and an infrared light signal; and the visible-light filter is arranged in front of the image capture means and configured to filter out a visible light signal in the projected image, so that the image capture means captures the infrared light indicating signal on the projected image, and the computation processing device performs related operations according to the infrared light indicating signal.

As such, in the human-machine interaction system and the infrared image capture device provided in the present disclosure, the visible-light filter is arranged in front of the image capture means to filter out visible light signals but pass infrared light signals through, thus avoiding the use of an expensive infrared camera. Therefore, the human-machine interaction system and the infrared image capture device provided in the present disclosure have low costs and are advantageous in promotion; further, merely infrared light indicating signals are captured by the infrared image capture device of the present disclosure and will not be interference by other visible light signals, so that the computation processing device can easily analyze and determine the position of the infrared light indicating signal precisely, thereby eliminating a human-machine interaction failure, and avoiding the defect of incomplete frame images caused by frame rate differences between the projector and the image capture means and the light source.

The summary of the technical schemes of the present disclosure is provided as above. For better understanding on the technical means in the present disclosure and the implementation according to the description, as well as making the above and other objects, features and advantages of the present disclosure more apparent, detailed description is made below with reference to the accompanying drawings and preferred embodiments.

### DESCRIPTION OF DRAWINGS

FIG. 1 is a schematic diagram of a human-machine interaction system according to an embodiment of the present invention; and

FIG. 2 is a schematic diagram of an infrared image capture device 140 shown in FIG. 1

### DETAILED DESCRIPTION OF THE EMBODIMENTS

To further illustrate technical means employed in the present disclosure to achieve predetermined objects and effects thereof, implementations, methods, steps, structures, features and effects of a human-machine interaction system and an infrared image capture device provided according to the present disclosure are described in detail below in combination with the accompanying drawings and preferred embodiments.

The above and other technical means, features and effects will be made apparent from the detailed description of the preferred embodiments made in conjunction with the accompanying drawings. The description of the specific embodiments would facilitate the comprehensive and concrete understanding of the technical means employed in the present disclosure to achieve predetermined objects and effects thereof, but the accompanying drawings, which are used for reference and description, are not intended to limit the present disclosure.

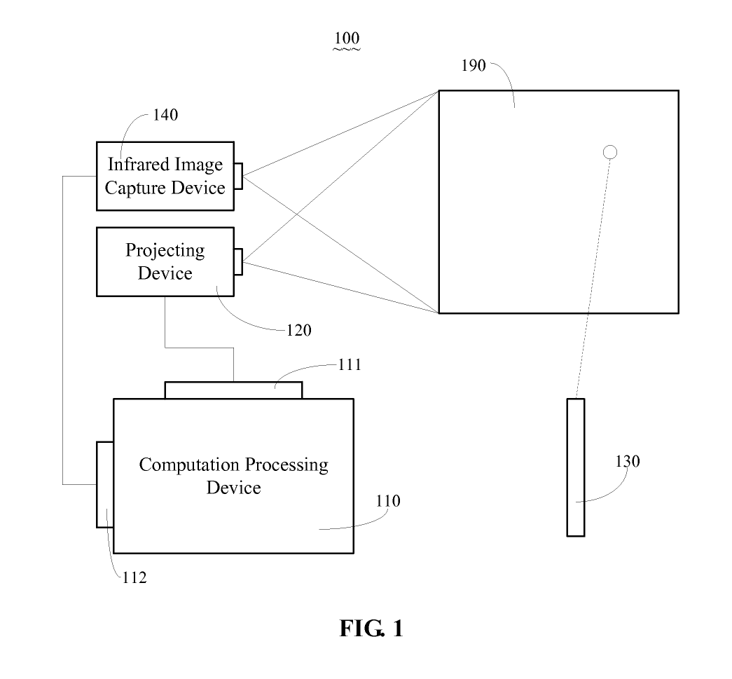

As shown in FIG. 1 which is a schematic diagram of a human-machine interaction system according to an embodiment of the present invention, a human-machine interaction system 100 in the embodiment of the present invention includes a computation processing device 110, a projecting device 120, an infrared light generator 130, and an infrared image capture device 140.

The computation processing device 110 refers to a computation system with a computation processing capability, such as a computation system with electronic components such as a Central Processing Unit (CPU) and a memory and an operating system providing a program executing environment. Particularly, the computation processing device 110 may be embodied by various computers, such as a desktop computer, a notebook computer and a tablet computer, or by hand-held devices with a computation processing capability such as an intelligent mobile phone, or by a robot with a computation processing capability, and so on.

The projecting device 120, which is connected with the computation processing device 110, is configured to project an image from the computation processing device 110 to a projection area 190 to generate a corresponding projected image. The projecting device 120 may be connected with the computation processing device 110 via a projecting device interface 121, which may be a Video Graphic Array (VGA) interface, a compound video output interface, a High Definition Multimedia Interface (HDMI), etc. Of course, the projecting device 120 may be alternatively connected with the computation processing device 110 via other wired or wireless connection manners.

The infrared light generator 130 is configured to output an infrared light signal to generate an infrared light indicating signal on a projected image in the projection area 190. The infrared light generator 130 may be embodied by an infrared laser, which emits an infrared laser beam that hits the projection area 190 to form the infrared light indicating signal, in this case, the infrared light indicating signal may be a light spot of the infrared laser beam.

The infrared image capture device 140, which is connected with the computation processing device 110, is configured to capture the infrared light indicating signal on the projected image and input the captured infrared light indicating signal to the computation processing device 110, so that the computation processing device 110 can determine a position of the infrared light indicating signal on the projected image, to implement the human-machine interactions.

The infrared image capture device 140 may be connected with the computation processing device 110 via an image capture interface 141. For example, the infrared image capture device 140 may be a Universal Serial Bus (USB) camera device which is connected with the computation processing device 110 via a USB interface. Or, the infrared image capture device 140 is built in and hence connected with the computation processing device 110. Or, the infrared image capture device 140 is connected with the computation processing device 110 via a wireless connection manner (such as a WiFi connection). Additionally, control software may be installed in the computation processing device 110 to control the infrared image capture device 140 to operate to capture the infrared light indicating signal on the projected image.

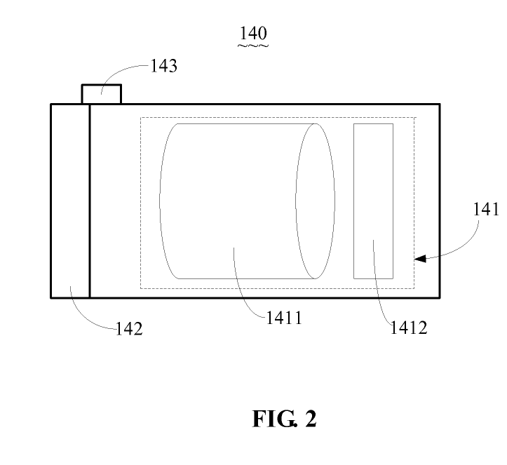

As shown in FIG. 2 which is a schematic diagram of the infrared image capture device 140 shown in FIG. 1, the infrared image capture device 140 of the present disclosure includes image capture means 141 and a visible-light filter 142.

The image capture means 141 is capable of capturing both a visible light signal and an infrared light signal. In the present disclosure, the image capture means 141 may be embodied by a conventional camera without infrared cut-off filter. Conventionally, a conventional camera includes an infrared cut-off filter. The camera used in the present disclosure may be a conventional camera that is modified to remove its infrared cut-off filter, to enable the conventional camera to capture the visible light signal and the infrared light signal without increasing costs. Of course, the conventional camera used in the present disclosure may be a camera for which an infrared cut-off filter is not provided in manufacturing.

The image capture means 141 includes a lens 1411 and a photosensitive member 1412 arranged behind the lens 1411. The photosensitive member 1412 may be embodied by a Charge-Couple Device (CCD) or a Complementary Metal-Oxide Semiconductor (CMOS). Of course, it may be understood by those skilled in the art that the number and type of the lens 1411 in the image capture means 141 may be varied as desired.

The visible-light filter 142 is arranged in front of the image capture means 141, so that the visible light signal in the projected image is filtered out by the visible-light filter 142 but the infrared light indicating signal on the projected image is allowed to pass through the visible-light filter 142 before the projected image is captured by the image capture means 141, so that the image capture means 141 captures merely the infrared light indicating signal on the projected image and sends the infrared light indicating signal to the computation processing device 110, finally the computation processing device 110 can distinguish and identity the position of the infrared light indicating signal on the projected image, and perform related operations according to the infrared light indicating signal, thereby implementing the human-machine interaction.

In addition, as shown in FIG. 2, the infrared image capture device 140 may further include a switching member 143, which is connected with the visible-light filter 142 so as to lift or lower the visible-light filter 142, for the purpose of selectively arranging the visible-light filter 142 in front of the image capture means 141. For example, to capture both the projected image and the infrared light indicating signal on the projected image by the human-machine interaction system 100, the switching member 143 is actuated to lift the visible-light filter 142, so that the image capture means 141 can capture both the visible light signal and the infrared light signal. Otherwise, to capture merely the infrared light indicating signal on the projected image, the switching member 143 is actuated to lower the visible-light filter 142, so that the visible light signal is filtered out and the image capture means 141 captures merely the infrared light signal.

As such, in the human-machine interaction system and the infrared image capture device provided in the present disclosure, the visible-light filter is arranged in front of the image capture means to filter out visible light signals but pass infrared light signals through, thus avoiding the use of an expensive infrared camera. Therefore, the human-machine interaction system and the infrared image capture device provided in the present disclosure have low costs; further, merely infrared light indicating signals are captured by the infrared image capture device of the present disclosure and will not be interference by other visible light signals, so that the computation processing device can easily analyze and determine the position of the infrared light indicating signal precisely, thereby eliminating a human-machine interaction failure, and avoiding the defect of incomplete frame images caused by frame rate differences between the projector and the image capture means and the light source.

As such, the preferred embodiments of the present invention have been described as above, but are not intended to formally limit the disclosure in any way. In light of the technical means disclosed as above, changes and modifications resulting in equivalent variants of the embodiment may be made by those of ordinary skills in the art without departing from the scope of the invention. Therefore, any such changes, variants and modifications made on the above embodiments in light of the essence of the invention without departing from the scope of the invention fall within the scope of the invention.

1. An infrared image capture device of a human-machine interaction system, comprising:
image capture means, which is capable of capturing a visible light signal and an infrared light signal, and
a visible-light filter, which is arranged in front of the image capture means and configured to filter out the visible light signal in an projected image before the projected image is captured by the image capture means, so that the image capture means captures the infrared light signal on the image.

2. The infrared image capture device of claim 1, wherein, the image capture means is a camera without an infrared cut-off filter.

3. The infrared image capture device of claim 2, wherein, the image capture means comprises a lens and a photosensitive member arranged behind the lens.

4. The infrared image capture device of claim 1, further comprising: a switching member which is connected with the visible-light filter and configured to control the visible-light filter to be selectively arranged in front of the image capture means.

5. A human-machine interaction system, comprising:
a computation processing device,
a projecting device, which is connected with the computation processing device and configured to project an image from the computation processing device to a projection area to generate a projected image,
an infrared light generator, which is configured to output an infrared light indicating signal on the projected image, and
an infrared image capture device, which is configured to capture the infrared light indicating signal on the projected image,
wherein the infrared image capture device comprises: image capture means, which is capable of capturing a visible light signal and an infrared light signal; and a visible-light filter, which is arranged in front of the image capture means and configured to filter out a visible light signal in the projected image, so that the image capture means captures the infrared light indicating signal on the projected image, and the computation processing device performs related operations according to the infrared light indicating signal.

6. The human-machine interaction system of claim 5, wherein, the image capture means is a camera without an infrared cut-off filter.

7. The human-machine interaction system of claim 6, wherein, the image capture means comprises a lens and a photosensitive member arranged behind the lens.

8. The human-machine interaction system of claim 5, where in the infrared image capture device further comprises: a switching member which is connected with the visible-light filter and configured to control the visible-light filter to be selectively arranged in front of the image capture means.

9. The human-machine interaction system of claim 5, wherein the computation processing device is a computing system, which is installed with an operating system and provides an environment for executing a program.

10. The human-machine interaction system of claim 5, wherein the computation processing device is installed with control software, which is operable to control the infrared image capture device to capture the infrared light indicating signal on the projected image.
